(19) United States
(12) Patent Application Publication
(10) Pub. No.: US 2010/0056380 A1
(43) Pub. Date: Mar. 4, 2010

(54) COMBINATORIAL BIOMINERALIZATION ARRAYS

(76) Inventor: Dong June Ahn, Seoul (KR)

Correspondence Address: EDWARDS ANGELL PALMER & DODGE LLP, P.O. BOX 55874, BOSTON, MA, 02205, US

(21) Appl. No.: 12/200,893

(22) Filed: Aug. 28, 2008

(51) Int. Cl. C40B 30/00; C40B 40/04; C40B 40/08; C40B 40/10

(52) U.S. Cl. 506/7; 506/15; 506/17; 506/18

(57) ABSTRACT

Systems and methods employing combinatorial arrays for revealing factors which control biomineralization processes. An understanding of such control factors may be expected to allow those of skill in the art to mimic biomineralization processes so as to allow manufacture of engineered synthetic biomineralized products, such as artificial bones. Such products would be expected to have structure and properties similar or identical to natural products (e.g., bones), and exhibit improved immunological acceptance when implanted as compared to existing synthetic engineered products.

### TECHNICAL FIELD

The present application relates generally to combinatorial arrays and related methods.

### BACKGROUND

Biomineralization refers to natural processes by which living organisms produce mineralized structures such as skeletons, bones, shells, and other structures. As yet, the understanding of how biomineralization occurs is insufficient to allow use of the underlying processes for manufacture of engineered biomaterials having properties that mimic natural biomineralized structures.

### BRIEF SUMMARY

According to one embodiment, a illustrative method includes: providing a combinatorial array including a substrate and a plurality of synthesis locations, each location including a surface functional member (e.g., a surface functional ligand) such that the combinatorial array includes a plurality of different surface functional members; exposing the plurality of synthesis locations to one or more biomineralization reagents comprising a first chemical synthesis step so as to react at least some of the different surface functional members with one or more reagents of the first chemical synthesis step so as to produce functional members that are modified by the first chemical step; and exposing the plurality of synthesis locations to one or more biomineralization reagents comprising a second chemical synthesis step so as to react at least some of the surface functional members and/or first step modified surface functional members with the one or more reagents of the second chemical synthesis step so as to produce second step modified surface functional members.

According to another embodiment, a biomineralization combinatorial array includes a substrate and a plurality of synthesis locations located on the substrate, each location including a surface functional member comprising a surface functional biomineralization ligand such that the substrate includes a plurality of different surface functional biomineralization ligands.

This summary is provided to introduce a selection of concepts in a simplified form that are further described below in the Detailed Description. This summary is not intended to identify key features or essential characteristics of the claimed subject matter, nor is it intended to be used as an aid in determining the scope of the claimed subject matter.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 schematically illustrates an illustrative biomineralization combinatorial array.

FIG. 2A is a close-up view of one illustrative synthesis location including a given surface functional biomineralization ligand.

FIG. 2B is a close-up view of another illustrative synthesis location including a surface functional biomineralization ligand that is different from the ligand of the synthesis location of FIG. 2A.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein.

The subject matter disclosed herein relates to systems and methods employing combinatorial arrays for revealing factors which control biomineralization processes, for example. An understanding of such control factors as provided by the present combinatorial arrays may be expected to allow those of skill in the art to mimic biomineralization processes so as to allow manufacture of engineered synthetic biomineralized products, such as artificial bones. Such artificial bones would be expected to have structure and properties similar or identical to natural bones, for example, including a crystalline structure composed of inorganic (e.g., calcium phosphates) as well as organic (e.g., proteins) compounds. Such engineered products would be expected to exhibit improved immunological acceptance when implanted as compared to existing synthetic engineered products.

According to one embodiment, a biomineralization combinatorial array includes a substrate and a plurality of synthesis locations located on the substrate, each location including a surface functional member comprising a surface functional biomineralization ligand such that the substrate includes a plurality of different surface functional biomineralization ligands.

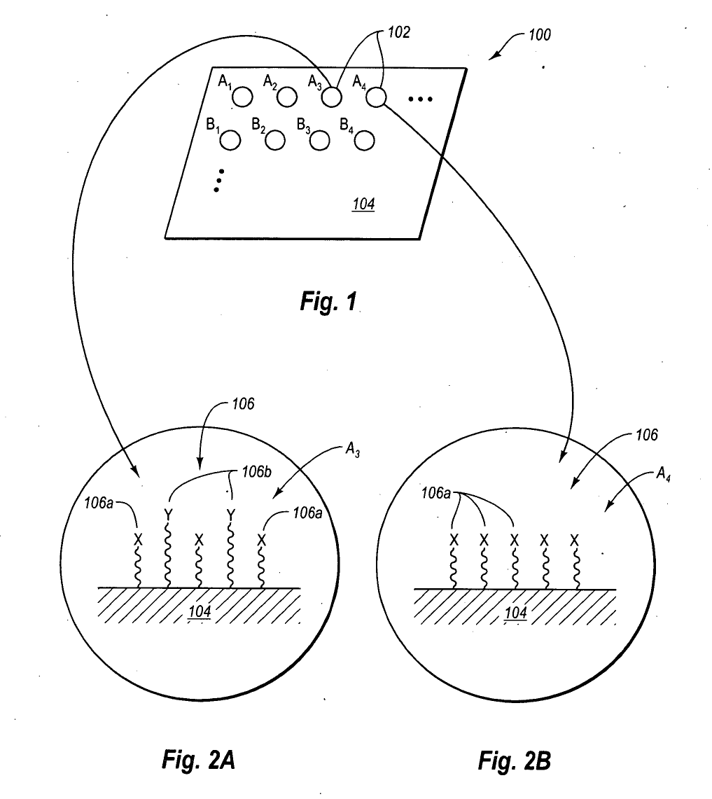

FIG. 1 schematically illustrates an exemplary biomineralization combinatorial array 100 including a plurality of synthesis locations 102 (e.g., A₁, A₂, A₃, A₄ . . . B₁, B₂, B₃, B₄ . . . ) associated with (e.g., located on) substrate 104. The substrate may be formed of any suitable material, an example of which is silicon. As many synthesis locations as desired may be provided. For example, in one broad range the substrate includes at least about 50 synthesis locations. In an intermediate range the substrate includes at least about 1000 synthesis locations. In a narrow range the substrate includes at least about 10,000 synthesis locations.

As illustrated in FIGS. 2A and 2B, each synthesis location 102 includes a surface functional member comprising a biomineralization ligand. For example, FIG. 2A shows a close-up view of an illustrative synthesis location A₃, while FIG. 2B shows a close up view of an illustrative synthesis location A₄. As shown in FIG. 2A, synthesis location A₃ includes a surface functional ligand or arrangement of surface functional ligands 106 (schematically represented by X terminated members 106a and Y terminated members 106b).

Each synthesis location may include a different surface functional ligand or grouping of ligands, as shown by FIG. 2B, in which the synthesis location A₄ is illustrated with an arrangement of surface functional ligands 106 (schematically represented by X terminated members 106a) that is different from the arrangement of synthesis location A₃ (FIG. 2A).

Examples of surface functional biomineralization ligands comprise groups such as, but not limited to, acids, alcohols, aldehydes, esters, methyls, halides (e.g., fluorines), sulfates, phosphates, polynucleotides, polypeptides, and their mixtures.

According to one exemplary method of use, a combinatorial array including a substrate and a plurality of synthesis locations is provided. Each location includes a surface functional member (e.g., a surface functional ligand) such that the combinatorial array includes a plurality of different surface functional members. The plurality of synthesis locations are exposed to one or more biomineralization reagents comprising a first chemical synthesis step so as to react at least some of the different surface functional members with the one or more reagents of the first chemical synthesis step so as to produce functional members that are modified by the first chemical step. The plurality of synthesis locations are then exposed to one or more additional (e.g., different) biomineralization reagents comprising a second chemical synthesis step so as to react at least some of the surface functional members and/or first step modified surface functional members with the one or more reagents of the second chemical synthesis step so as to produce second step modified surface functional members. Additional chemical synthesis steps (e.g., third, fourth, fifth, etc.) may be performed with additional and/or other biomineralization reagents in order to further react and modify the surface functional ligands of the synthesis locations.

In one embodiment, the one or more reagents used within the first, second, or any other of the chemical synthesis steps comprise inorganic biomineralization reagents. Such reagents may include natural bone-forming or natural precipitate-forming ingredients. Examples of such inorganic reagents include, but are not limited to, silicates, carbonates, calcium phosphates, calcium carbonates, and combinations thereof. Such reagents may comprise aqueous solutions (e.g., seawater, physiological saline, supersaturated man-made solutions containing mineralizing reagents, or another solution mimicking the solutions present in a natural environment in which biomineralization occurs). For example, the silicates, carbonates, calcium phosphates, and calcium carbonates in a broad range may comprise between about 0.0001 percent and about 50 percent by weight of the aqueous solution. In an intermediate range, they may comprise between about 0.1 percent and about 30 percent by weight of the aqueous solution. In a narrow range, they may comprise between about 1 percent and about 10 percent by weight of the aqueous solution.

In another embodiment, the one or more reagents of one or more of the chemical synthesis steps may comprise organic biomineralization reagents (e.g., one or more proteins). Examples of such organic reagents include, but are not limited to, chemicals containing groups such as, but not limited to, acids, alcohols, aldehydes, esters, methyls, halides (e.g., fluorines), sulfates, phosphates, polynucleotides, polypeptides, and their mixtures. For example, the organic reagents in a broad range may comprise between about 0.0001 percent and about 50 percent by weight of the aqueous solution. In an intermediate range, they may comprise between about 0.1 percent and about 30 percent by weight of the aqueous solution. In a narrow range, they may comprise between about 1 percent and about 10 percent by weight of the aqueous solution.

In one exemplary method, both organic and inorganic reagents are used, as typical biomineralized materials include both inorganic materials (e.g., silicates, carbonates, calcium phosphates, and/or calcium carbonates) as well as organic (e.g., protein) materials within their structure. Reacting the surface functional ligands of the combinatorial array would be expected to result in the synthesis of a synthetic biomineralized material—i.e., a material having properties and structure similar to that of natural biomineralized materials. Such materials may comprise a composite material including an organic (e.g., protein) portion as well as an inorganic portion. Analysis of such combinatorial methods, as well as the materials produced therefrom would be expected to reveal factors controlling the biomineralization.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for revealing factors which control biomineralization comprising:
providing a combinatorial array including a substrate and a plurality of synthesis locations, each synthesis location including a surface functional member such that the combinatorial array includes a plurality of different surface functional members;
exposing the plurality of synthesis locations to one or more reagents comprising a first chemical synthesis step so as to react at least some of the different surface functional members with the one or more reagents of the first chemical synthesis step so as to produce first step modified surface functional members;
exposing the plurality of synthesis locations to one or more reagents comprising a second chemical synthesis step so as to react at least some of the surface functional members or first step modified surface functional members with the one or more reagents of the second chemical synthesis step so as to produce second step modified surface functional members;
wherein the reagents of the first and second chemical synthesis steps comprise biomineralization reagents.

2. A method as recited in claim 1, wherein the surface functional members comprise surface functional ligands.

3. A method as recited in claim 2, wherein the surface functional ligands comprise one or more functional groups selected from the group consisting of acids, alcohols, aldehydes, esters, methyls, halides, sulfates, phosphates, polynucleotides, polypeptides, and their mixtures.

4. A method as recited in claim 1, wherein the one or more reagents of the first or second chemical synthesis step comprise inorganic biomineralization reagents.

5. A method as recited in claim 4, wherein the inorganic biomineralization reagents are selected from the group consisting of silicates, carbonates, calcium phosphates, and calcium carbonates.

6. A method as recited in claim 5, wherein the one or more reagents of the first chemical synthesis step comprise aqueous solutions.

7. A method as recited in claim 6, wherein the silicates, carbonates, calcium phosphates, and calcium carbonates comprise between about 1 percent and about 10 percent by weight of the aqueous solution.

8. A method as recited in claim 1, wherein the one or more reagents of the first or second chemical synthesis step comprise organic biomineralization reagents.

9. A method as recited in claim 7, wherein the organic biomineralization reagents comprise chemicals containing one or more functional groups selected from the group consisting of acids, alcohols, aldehydes, esters, methyls, halides, sulfates, phosphates, polynucleotides, polypeptides, and their mixtures.

10. A method as recited in claim 9, wherein the organic biomineralization reagents comprise one or more proteins.

11. A method as recited in claim 9, wherein the proteins comprise between about 1 percent and about 10 percent by weight of the organic biomineralization reagents.

12. A method as recited in claim 1, wherein one or more reagents of the first or second chemical synthesis step comprise both inorganic and organic biomineralization reagents, and wherein at least one of the second step modified surface functional members comprises a biomineralized material.

13. A method as recited in claim 12, wherein the biomineralized material comprises a composite material including an organic portion and an inorganic portion.

14. A method as recited in claim 13, wherein the organic portion comprises a protein.

15. A method as recited in claim 13, wherein the inorganic portion comprises one or more of a silicate, a carbonate, a calcium phosphate, or a calcium carbonate.

16. A biomineralization combinatorial array comprising:
a substrate;
a plurality of synthesis locations disposed on said substrate, each synthesis location including a surface functional member such that the substrate includes a plurality of different surface functional members; and
wherein the surface functional members comprise surface functional biomineralization ligands.

17. A biomineralization combinatorial array as recited in claim 16, wherein the surface functional biomineralization ligands comprise one or more functional groups selected from the group consisting of acids, alcohols, aldehydes, esters, methyls, halides, sulfates, phosphates, polynucleotides, polypeptides, and their mixtures.

18. A biomineralization combinatorial array as recited in claim 16, wherein at least about 50 synthesis locations are disposed on said substrate.

19. A biomineralization combinatorial array as recited in claim 16, wherein the substrate comprises one or more of silicon, gold, silver, glass, a polymer or a ceramic.
